(19) United States
(12) Patent Application Publication
(10) Pub. No.: US 2026/0042459 A1
(43) Pub. Date: Feb. 12, 2026

(54) OBJECT CLASSIFICATION SYSTEM FROM UNSTRUCTURED POINT CLOUDS

(71) Applicant: The Boeing Company, Arlington, VA (US)

(72) Inventor: Michael Brandon SCHWIESOW, Toney, AL (US)

(73) Assignee: The Boeing Company, Arlington, VA (US)

(21) Appl. No.: 18/797,187

(22) Filed: Aug. 7, 2024

(51) Int. Cl. B60W 60/00; G01S 17/931; G05D 1/437; G06V 10/764

(52) U.S. Cl. CPC B60W 60/001; G01S 17/931; G05D 1/439; G06V 10/764; B60W 2554/40

(57) ABSTRACT

An object classification system may be present on a vehicle with a computing device connected to a sensor mounted on the vehicle. In response to an object positioned in a field of view of the sensor, the computing device may determine a state of the object after calculating a relative shape stability value for the object over time. The computing device may then deviate from a predetermined route for the vehicle in response to a classification of the object as a dynamic state.

### TECHNICAL FIELD

The present disclosure is directed to an object classification with an unstructured point cloud and, more particularly, to autonomous activity for a vehicle.

### BACKGROUND

As sensors and sensor networks become more ubiquitous, various activities have the opportunity to be supplemented by computer intelligence. While providing sensed information to a human in intelligent manners has been employed in the past, modern sensor systems have attempted to employ computer intelligence to automate aspects of various tasks. Such automation may provide increased safety, efficiency, or both in many activities when the computer intelligence operates correctly.

However, the proper operation of a sensor, or collection of sensors, may be inconsistent and/or inaccurate for a variety of environmental and/or functional situations. For instance, moisture may cause one or more sensors to read incorrectly and produce information that may cause a human operator to conduct inefficient reactions. Accordingly, there is a continued need for improved object identification for autonomous, and semi-autonomous, systems for vehicles, such as aircraft, automobiles, and robots.

### SUMMARY

In accordance with various aspects of the disclosure, an object classification system may be present on a vehicle with a computing device connected to a sensor mounted on the vehicle. In response to an object positioned in a field of view of the sensor, the computing device determines a state of the object after calculating a relative shape stability value for the object over time. The computing device then deviates from a predetermined route for the vehicle in response to a classification of the object as a dynamic state.

Other embodiments of an object classification system detects an object with a sensor before calculating a relative shape stability value for the object over time. A computing device then determines a state of the object in response to the relative shape stability value and calculates the relative shape stability value. In response to a classification of the object as a dynamic state by the computing device, a deviation from a predetermined route for the vehicle is prescribed.

An object classification system, in some embodiments, detects a first object and a second object with a sensor prior to calculating a relative shape stability value for each of the first object and second object over time with a computing device. A first state of the first object is determined by the computing device in response to the calculated relative shape stability value and a second state of the second object is determined by the computing device in response to the calculated relative shape stability value. Each of the first object and second object are classified by the computing device as a dynamic state before the computing device deviates from a predetermined route for the vehicle in response to a tracked dynamic state of first object.

### BRIEF DESCRIPTION OF THE DRAWINGS

Further advantages and features of the present disclosure will become apparent from the following description and the accompanying drawings, to which reference is made.

FIG. 1 illustrates portions of a taxiing environment in which assorted embodiments can be practiced.

FIG. 2 illustrates aspects of the taxiing environment of FIG. 1 operated in accordance with various embodiments of this disclosure.

FIG. 3 illustrates a flowchart of a process that may be carried out in the taxiing environment of FIG. 1 in accordance with assorted embodiments of this disclosure.

FIG. 4 illustrates a flowchart of a process that may be carried out in the taxiing environment of FIG. 1 in accordance with some embodiments of this disclosure.

FIG. 5 illustrates a flowchart of a process that may be carried out in the taxiing environment of FIG. 1 in accordance with various embodiments of this disclosure.

FIG. 6 illustrates portions of a taxiing environment employing assorted embodiments of this disclosure.

FIG. 7 illustrates a block representation of aspects of an object classification system that may be utilized in a taxiing environment in some embodiments.

FIG. 8 illustrates aspects of an object classification system operated in accordance with various embodiments of this disclosure.

FIG. 9 illustrates portions of an aircraft employing an object classification system in accordance with embodiments of this disclosure.

### DETAILED DESCRIPTION

Embodiments of the disclosure are generally directed to a system that accurately and efficiently detecting and classifying objects in a field of view. The ability to properly classify objects as static or dynamic obstacles allows the object classification system to support piloted, autonomous, or semi-autonomous, operation of equipment, such as aircraft or other vehicles.

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

As sensor and computing technology advance to provide faster data collection, automation of manual activities has become more attainable. The addition of machine learning and/or artificial intelligence has further allowed sensor information to be utilized to automate more complex activities. However, the quality of sensor information may, at times, present challenges to the accurate automation of an activity. For instance, automation of aircraft, and other vehicle, movement on the ground, which may be characterized as taxiing, can be jeopardized in the event that sensor information provides inaccurate information or malfunctions. Hence, various embodiments of the present disclosure are directed to an object classification system that accurately interprets sensor information to allow for the automation, or partial automation, of complex activities.

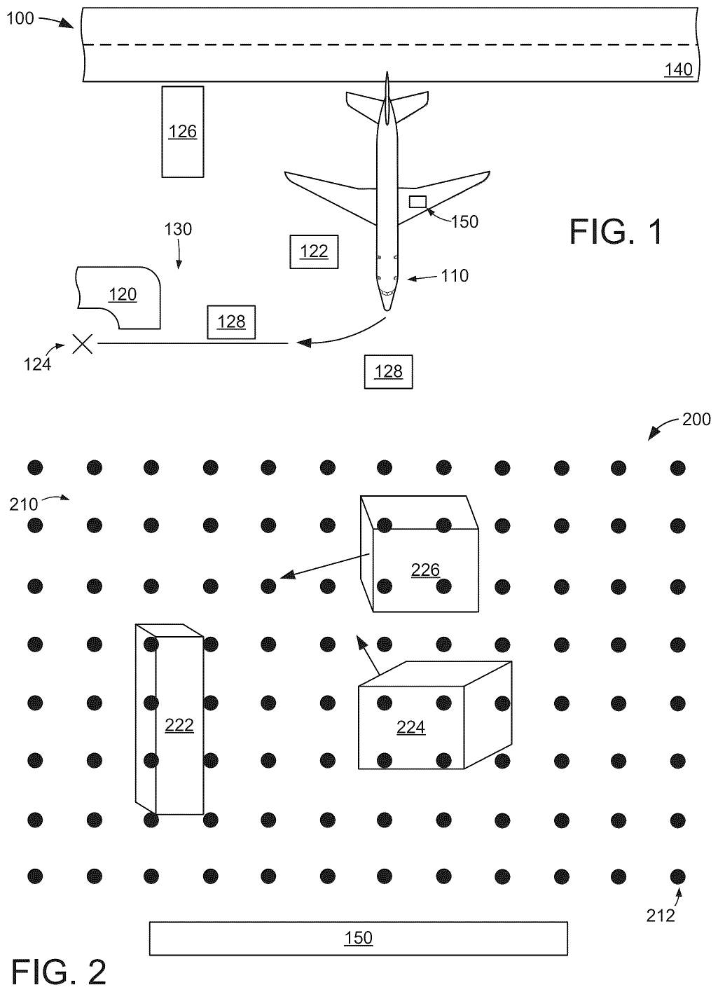

Turning to the drawings, FIG. 1 illustrates portions of a sensing environment 100 in which assorted embodiments of the present disclosure may be practiced. The top view of the sensing environment 100 conveys how an aircraft 110, such as an airplane, glider, vertical takeoff and landing (VTOL) airplane, autonomous drone, semi-autonomous airplane, or other lifting body, may be positioned during a taxiing operation with a gate 120.

While not required or limiting, the gate 120 may be a portion of a site 130, such as an airport, hanger, or other facility, that functionally services aspects of the aircraft 110. It is noted that the gate 120 may be one or many similar, or dissimilar, gates 120 operating concurrently, or sequentially, to transfer cargo, such as humans, animals, or containers, between the site 130 and the aircraft 110. It is further noted that the gate 120 may be any structural configuration that accesses one or more ports of the aircraft 110, such as a door, hatch, or window.

The operation of the gate 120 to provide ingress to, or egress from, the aircraft 110 may be relatively straightforward and often is carried out safely and efficiently. However, moving and positioning the aircraft 110 relative to the gate 120 during a taxiing operation may be more complicated while presenting hazards and obstacles the jeopardize the safety of the aircraft 110 itself and the contents of the aircraft 110.

In an effort to align portions of the aircraft 110 with the gate 120, one or more static indicators 122 may be positioned along a route from a runway 140 to the gate 120. The term “runway” is used herein to include a defined area for the landing and takeoff of the aircraft 110, taxiways for general movement of assorted objects and aircraft 110, and general areas that facilitate blast pads and overruns. The surface of the runway 140 may be a natural material, such as dirt, water, or ice, as well as combinations of materials, such as concrete or asphalt. A runway 140, in some embodiments, includes a water surface, a strip for training the aircraft 110, which may be adjacent to another runway 140, a vertiport, or a heliport.

An aircraft 110 may include flying vehicles, such as, for example, but not limited to, commercial aircraft, private aircraft, military aircraft, watercraft, and helicopters among other types of flying, or hovering, vehicles. Runways 140, for example, may be any dimensions, such as 800 feet long by 26 feet wide or 40,000 feet long by 900 feet wide. A runway 140 may be virtual in some embodiments. Such a virtual runway 140 may, or may not, have visual markings. Other runways 140 may be non-precision instrument runways that include visual markings, such as centerlines for horizontal guidance, aiming points for vertical position guidance, and buoys. For precision instrument runways 140, blast pad, overrun areas, beginning space markers, ending space markers, centerlines, aiming points buoys, and other approach guidance fiducials may be included. There are, for example, single runways, parallel runways, intersecting runways, and open-V runway configurations, none of which are required or limiting to practice the assorted sensing embodiments of the present disclosure.

A static indicator 122 may be any diagram, symbol, or text located on a permanent, or temporary, surface. For instance, a parking region 124 of a paved ground surface may be occupied by lines and symbols associated with desired parking position of an aircraft 110 while text may be present on a selectable sign 126. Static indicators 122 may operate in concert with dynamic indicators 128, such as humans, motorized equipment, and flashing lights, to identify conditions, status, and instructions to an aircraft 110 during a taxiing operation between the gate 120 and the runway 140.

Despite the presence of static 122 and/or dynamic 128 indicators, taxiing operations may be time consuming and wrought with dangerous situations that occur quickly and change frequently. Interpretation of the assorted indicators 122/128 may be conducted by human operators, which employ the indicator information to execute a variety of different tasks and adjustments for taxiing operations. Human evaluation and activity may provide safe taxiing operations in some situations based on numerous different environmental and situational considerations. Yet, human operators may be susceptible to errors, lapse in judgement, and inabilities to ascertain some situations accurately.

Accordingly, one or more sensors 150 may be employed to aid human operators in accurately identifying indicators 122/128, obstacles, and environmental conditions during taxiing operations. Sensors 150 may further be utilized to automate aspects of a taxiing operation. It is noted that any number of sensors may be positioned anywhere to gather information about aircraft 110, gates 120, indicators 122/128, and other conditions. Regardless of the position of a sensor 150, gathered information may use one or more sensing technologies to locate, identify, and/or track objects, text, and symbols. For instance, a sensor 150 may employ light, radio, or ultrasonic frequencies to gather information about aspects of the sensor's field of view.

Through the use of at least one sensor 150, safety and efficiency of various aspects of a taxiing operation may be enhanced. Specifically, the identification and tracking of objects with sensors 150 may enhance automated, or manual, avoidance.

Within the scope of the assorted embodiments of a sensing system that may be utilized in the sensing environment 100 of FIG. 1, or another environment, is a vehicle not capable of flight. For instance, the sensing environment 100 in which embodiments of a sensing system is practiced may be a road, bridge, highway, tunnel, or off-road trail traversed by a piloted, or autonomous, vehicle, such as a car, truck, van, or robot, without the ability to generate lifting forces greater than the weight of the vehicle itself. Accordingly, throughout the present disclosure the term “taxiing” operations may be synonymous with ground activity of a vehicle that does, or does not, have the ability to generate lift and fly on sites 130 that do, or do not, have gates 120, runways 140, or parking regions 124.

FIG. 2 illustrates portions of the sensing environment 100 when aspects of an object classification system 200 are employed in accordance with various embodiments. To clarify, the perspective view of FIG. 2 conveys a field of view of a sensor 150 as well as some of the information gathered by the sensor 150 and returned to a computing device 202 for processing and evaluation, which may be employed to automate aspects of a taxiing operation and/or indicate taxiing conditions to one or more human operators.

As shown, the sensor 150 creates an unstructured point cloud 210 that consists of a number of frequency points 212 respectively representing where frequency beams are emitted. Although not required or limiting, the frequency points 212 may be beams of visible, or non-visible light, sent from an emitter portion of the sensor 150, such as a mechanical optics or solid-state phase array, and collected by a detector portion of the sensor 150. For detection configurations utilizing such light frequencies, the sensor 150 may be characterized as a light detection and ranging (LiDAR) sensor that operate to evaluate three dimensions.

While the operation of a LIDAR sensor 150 may provide object detection and tracking in some, theoretical situations, the practical operation of LiDAR sensing technology may present challenges. For instance, objects that have low reflectivity may present challenges to the efficient and reliable tracking and characterization of the object as static, such as object 222, or dynamic, such as objects 224 and 226. Various weather conditions, such as fog, snow, and rain, may result in consistent, or false identification of an object's state and, consequently, the accurate tracking of dynamic objects 224/226.

Even under ideal object detection conditions, a LIDAR sensor 150 may experience degraded reliability and/or performance. For instance, the presence of multiple objects 224/226 in a common space of the sensor's 150 field of view may cause detection, characterization, and tracking issues. That is, detecting whether one, or multiple, objects are present may cause the sensor 150 to temporarily, or permanently, mistake the state, direction of movement, and/or speed of movement of one or more objects. The non-limiting example shown in FIG. 2 illustrates how objects 224/226 moving at different directions and speed, as indicated by the orientation and length of solid arrows, may be mischaracterized as a single, stationary object by the sensor 150 in some situations.

Although not required or limiting, a computing device 202 may operate over time to identify and track various aspects in a field of view by segmenting a ground surface, identifying objects, defining one or more bounding boxes, defining object states as dynamic or static, tracking dynamic objects over time, and planning for expected path and velocity of dynamic objects. Such processes may be relatively straightforward in some situations, but are complicated by movement of the sensors, environmental conditions, and inconsistent readings from assorted sensors. Hence, embodiments are generally directed to enhanced manners of utilizing multiple sensors to efficiently and reliably detect and track assorted aspects over time.

With the operational challenges associated with object detection and state characterization due to inaccurate and/or inefficient operation of one or more sensors, the safety and confidence of automating aspects of aircraft 110 operation may be jeopardized. As a result, the generation of automation instructions, tasks, and actions, such as during taxiing activities, may be susceptible to operational challenges. Thus, various embodiments are directed to a system for object detection and tracking for a aircraft 110 that provides enhanced object characterization and tracking that optimizes the automation of activities.

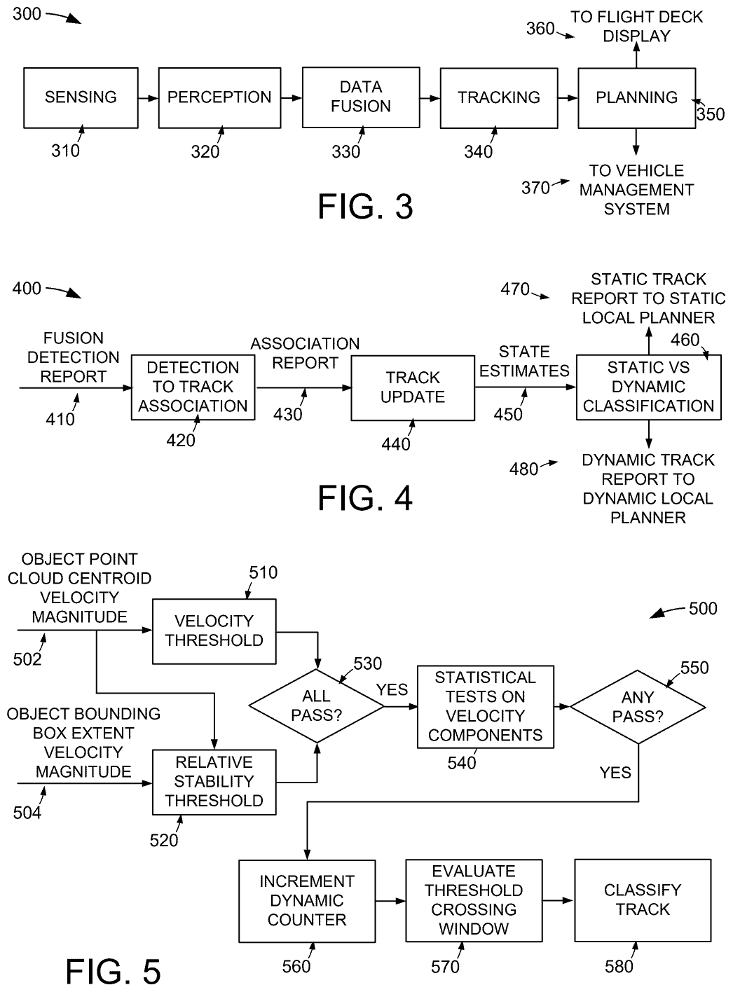

FIG. 3 displays a flowchart of a sensing process 300 that may be carried out with assorted aspects of a sensing system in the sensing environment 100 of FIG. 1. It is noted that the sensing process 300 may be executed by one or computing devices 202 that operate at least one sensor 150, such as a LiDAR, RADAR, acoustic, thermal, optical, or ultrasonic sensor, to collect information during movement of an aircraft 110 between a runway 140 and a designated parking region, such as a gate, hanger, or other stable location.

Initially, the sensing process 300 may activate one or more sensors 150 in step 310 to collect information about at least conditions and objects around an aircraft. A computing device next processes the gathered information from the connected sensors in step 320 to determine what is present within each sensor's field of view. That is, the computing device may separately characterize what different sensors detect in step 320 before combining the information from multiple sensors in step 330. The combination of information from different sensors in step 330 may provide efficient verification, redundancy, and error detection as the data from different sensors is compared by a computing device.

The combination of sensor data in step 330 may further allow for efficient state characterization of objects, which translates into efficient tracking of objects over time in step 340. The detection, characterization, and tracking of objects allows a computing device to generate and maintain one or more aircraft routes in step 340. In some embodiments, the route planning of step 350 may be supplemented by other information not generated by sensors, such as global policies, airport movement maps, and instructed aircraft movements.

The proactive planning of routes in step 350 allows for a variety of automated or manual responses, such as the individual, concurrent, or sequential transmission of planning data to a flight deck in step 360 and/or to a vehicle management system in step 370. For instance, proposed aircraft routes and information about conditions and objects may be passed directly to a manual operator that conducts taxiing operations. Information and proposed routes may, alternatively, be sent to a completely autonomous taxiing system that reacts to routes generated in step 340 with physical aircraft actions. Although the resulting information and routes from process 300 may be employed for purely manual or automated taxiing operations, other embodiments conduct taxiing operations with a combination of manual aspects and automated aspects. As such, the accurate operation of various redundant, or dissimilar, sensors may produce efficient and safe aircraft activities, particularly for taxiing operations.

In accordance with various embodiments, an aircraft, and/or aircraft landing site, may employ a more sophisticated version of the sensing process 300 of FIG. 3 in an effort to provide faster and more precise identification of objects, obstacles, and indicators to allow for greater route planning resolution and more seamless automated execution of prescribed aircraft actions. FIG. 4 depicts an example sensing routine 400 that may be conducted individually, or in combination with, the sensing process 300 of FIG. 3, to provide a greater understanding of the assorted aspects around an aircraft during a taxiing operation.

The sensing routine 400 may begin before, during, or after the data streams of multiple sensors are fused together through digital analysis and processing. With the results of sensor stream fusion, as illustrated by arrow 410, step 420 may detect assorted aspects of a field of view of the sensors utilized for the stream fusion. For instance, step 420 may employ computer processing to detect a ground, static objects, dynamic objects, indicators, and humans from the fused data streams of assorted sensors. As a result of the detection of step 420, an association of detected aspects may be generated, as represented by arrow 430.

Through the association of detected aspects from assorted sensors, step 440 can identify moving portions and update tracking information, which allows for the verification, or alteration, of the state of an object, identifier, or human, as represented by arrow 450. The updating of tracking information in step 440 may, in some embodiments, allow for efficient and reliable estimates of the state of one or more aspects. Such estimation of a static or dynamic state may allow for more precise classification of the path and/or speed of a dynamic aspect.

With the known, and estimated, state of various detected aspects of a field of view, sensor information may be parsed in step 460 into aspects that are expected to remain stationary (static) and aspects that are expected to move (dynamic) while taxiing operations are conducted. The parsing of sensed aspects into static and dynamic portions may result in the assignment of regions of a field of view to a static planner in step 470 or to a dynamic planner in step 480. The separation of portions of a field of view may allow a computing device to conduct concurrent, or otherwise efficient, processing of real-time sensor information along with existing taxiing instructions, policies, and routes.

In accordance with various embodiments, multiple sensors may be concurrently employed to understand the environment in which taxiing operations are occurring. The fusion of sensor data and intelligent characterization of static and dynamic aspects of a field of view allows for efficient and reliable automation of some, or all, of a taxiing operation. Yet, the accurate detection and tracking of objects, indicators, and humans may correlate to efficiency and reliability of automation instructions and tasks. The inconsistent operation and/or accuracy of separate sensors, along with inherent susceptibility of some sensors to unreliable readings, may render automation evaluations challenging.

Accordingly, various embodiments provide enhanced detection and tracking with multiple sensors, particularly during taxiing operations with an aircraft. FIG. 5 conveys a flowchart of an intelligent sensing routine 500 that may provide enhanced utilization of multiple sensors to optimize automation of aspects of a taxiing operation. It is noted that the steps and decisions of routine 500 are not exclusive and may, in some embodiments, be carried out concurrently, or sequentially, with the sensing process 300 of FIG. 3 and the sensing routine 400 of FIG. 4.

Arrow 502 represents sensed information relating to the centroid velocity magnitude of one or more objects in a field of view. The bounding box extent velocity magnitude is also inputted, as represented by arrow 504. The centroid velocity magnitude is evaluated by the controller of one or more controllers of a computing device in step 510 against a predetermined velocity threshold and in step 520 against a predetermined relative stability threshold, in accordance with equation (1):

$${F}_{motion} = \vert {V}_{o b j} \vert \geq {V}_{thresh} \qquad ( 1 )$$

The parallel step of evaluating relative shape stability (RSS) is a subtlety which was uncovered through experimentation. As such, a relative shape stability threshold is utilized. The magnitude of the track velocity states must exceed a threshold to indicate object motion. With the combined information about the centroid velocity magnitude of an object and the bounding box extent velocity magnitude, step 520 may calculate the relative stability threshold according to equation (2):

$${F}_{R S S} = \vert {V}_{o b j} \vert - \vert {V}_{ext} \vert \geq RS {S}_{thresh} \qquad ( 2 )$$

The computation and analysis of the thresholds associated with object velocity and an object's relative stability allows decision 530 to determine if an object is actually moving. Once preliminary thresholding is passed in decision 530, hypothesis testing is conducted on the individual velocity components where the null hypothesis is that the object is static. If the null hypothesis is rejected for any object or object component, then a dynamic counter (N_{dyn}) is incremented for the current evaluation window. In the event a threshold from steps 510 or 530 are not met, routine 500 may return to gathering information, as illustrated by arrows 502 and 504.

Before making a classification decision, a measure of current track reliability (Tᵣₑₗᵢ) and dynamic consistency (D_{con}) are evaluated over the current evaluation window. To clarify, current track reliability may be defined as the number of missed detections in the current window since the last track update while dynamic consistency may be defined in equation (3):

$${D}_{c o n} = {N}_{d y n} - {T}_{r e l i} \qquad ( 3 )$$

The resulting dynamic consistency may then be employed to compute a dynamic motion verification metric (F_{win}) in equation (4):

$${F}_{win} = {D}_{c o n} \geq {D}_{thresh} \qquad ( 4 )$$

If F_{win} evaluates to true, then the track is classified as dynamic. Otherwise, an object is classified as static.

From decision 530, the sensing routine 500 conducts statistical tests on velocity components of an object in step 540 before evaluating the test results in decision 550. If an object verifies in decision 550 that the object is in motion, step 560 increments a dynamic counter and proceeds to step 570 where a window is computed, and/or evaluated, to determine when one or more thresholds will be crossed. The results of the threshold crossing window allows the routine 500 to classify the track of an object in step 580.

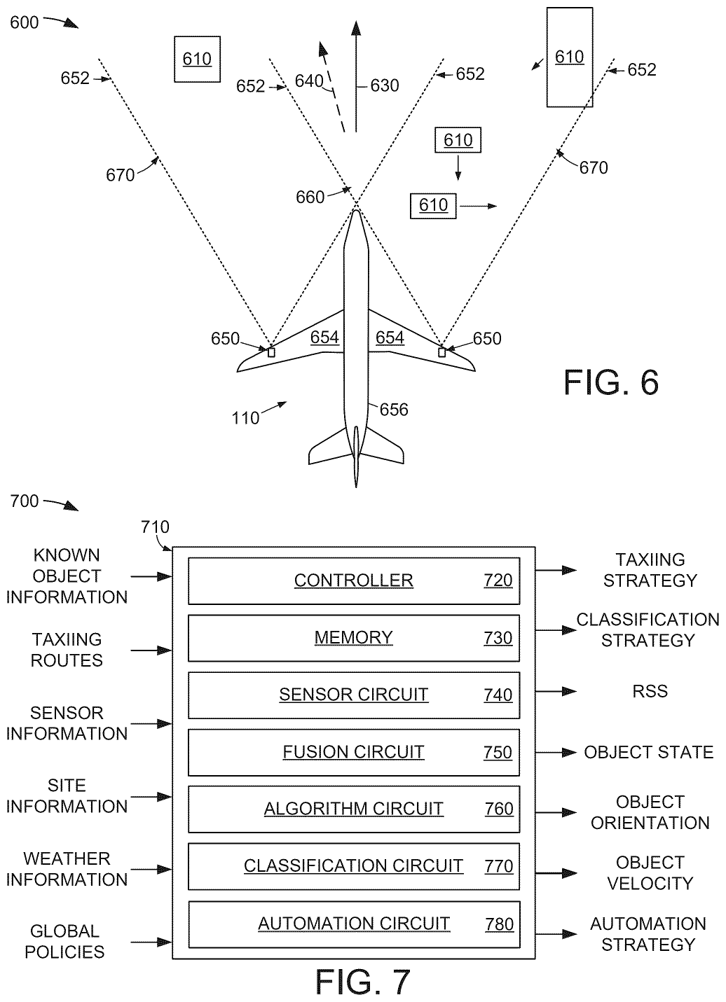

FIG. 6 illustrates a top view line representation of portions of a taxiing environment 600 in which assorted embodiments may provide enhanced object detection, classification, and tracking. The environment 600 may have any number, and type, of objects, indicators, and humans that are periodically, or consistently, static or moving over time. The non-limiting example shown in FIG. 6 has multiple dynamic objects 610, such as humans, equipment, or animals, moving in directions with velocities, as illustrated by solid arrows.

Along with the dynamic objects 610, the environment 600 has multiple static objects 620, such as signs, physical obstacles, and structures. The assorted objects 610/620 may move into, and out of, the field of view of an aircraft 110, particularly during taxiing operations between a runway and a designated parking region, such as a gate or hanger. The intended route 630 from runway to a designated parking region, or vice versa, may be influenced from a variety of informational sources, such as predetermined site policy, weather, and construction areas. The inclusion of manual supervision allows for efficient alteration of a set route 630 in response to dynamic 610 and/or static 620 objects. However, automating some, or all, of a taxiing operation to execute a route 630 that accounts for various objects 610/620 over time may present challenges.

It is noted that the automation of aspects of a taxiing operation may involve alerting a manual operator, such as a pilot or traffic controller, of potential hazards and route deviations, as illustrated by segmented arrow 640. Yet, the accurate operation of various system sensors, along with the efficient processing of sensor information into the position, direction of movement, and velocity of obstacles, indicators, hazards, and other dynamic objects, is needed to provide practical automation. That is, for automation information to effectively provide information to a human operator or to a controller for automated taxiing operations relies on both accurate operation of sensors and efficient processing of sensor information into objects and surfaces present in an aircraft's field of view.

In accordance with some embodiments, a sensing system may employ multiple separate sensors 650 positioned on the aircraft 110. The sensors 650 may have similar, or dissimilar fields of view, as illustrated by segmented lines 652, that may be statically or dynamically mounted to the wings 654 and/or fuselage 656 of the aircraft 110. It is noted that a sensing system may utilize a single sensor, such as a LIDAR, optical, thermal, or acoustic sensor, but such sensing configuration may provide a limited field of view that is more prone to inaccurate readings than sensing system embodiments that employ separate sensors 650 of the same type, such as LiDAR sensors.

The use of multiple, redundant sensors 650 may expand field of view, but may also present challenges for processing efficiency and accuracy. For instance, utilizing multiple separate LiDAR sensors 650, as illustrated in FIG. 6, may provide greater detection accuracy and efficiency in a middle portion 660 of the field of view and lesser detection accuracy and efficiency in edge portions 670 of the field of view. In other words, unstructured point clouds corresponding with multiple separate LiDAR sensors 650 may produce greater errors, such as false positives and incorrect object depth, while the redundant sensors 650 may provide enhanced detection in the middle portion 660.

With the difference in object detection accuracy in the respective field of view portions 660/670, despite having separate, redundant sensors 650, automation and automation instructions for taxiing operations may be degraded. That is, the presence of false positives, and other incorrect readings between sensors 650, may produce jerky, dangerous, and errant routing during automated taxiing activities. As a non-limiting example, a safe taxiing route 630 may be incorrectly altered due to a false positive reading of an object, which may jeopardize the safety of objects, indicators, and/or humans in the path of the altered route 640. It is noted that the unstructured point cloud employed by separate LiDAR sensors 650 may incorrectly account for object movement, state, direction, or velocity, which contributes to inconsistent, and potentially dangerous, automation instructions and activities for taxiing operations.

Accordingly, various embodiments are directed to a sensing system with optimized object classification via multiple, redundant LiDAR sensors 650 that detect via an unstructured point cloud. FIG. 7 illustrates a block representation of an object classification system 700 that may be employed in a taxiing environment 600 of FIG. 6 in various embodiments to provide improved detection accuracy and efficiency. The system 700 may be manifested in hardware and software in one or more computing devices 710 located on an aircraft 110, a taxiing site, or both.

A computing device 710 may employ one or more controllers 720, such as a microprocessor, system on chip, integrated circuit, or other programmable circuitry, that processes various input information, such as sensor information, existing site information, predetermined taxiing routes, weather information, and known object characteristics, to output various object detection, object classification, and automation instructions. It is contemplated that the computing device 710 may store various software, information, and data in one or more memories 730, such as permanent non-volatile solid-state memory cells, permanent magnetic sectors, or volatile solid-state cells.

Although the controller 720 may conduct any amount of processing to output assorted strategies, algorithm terms, and object characterizations, embodiments of the computing device 710 employ designated circuits that may operate alone, or in conjunction with the controller 720, to provide predetermined contributions to various strategies, object characterizations, and aircraft taxiing automation. For instance, the computing device 710 may have a sensor circuit 740 that verifies the operational state of the assorted connected sensors. A fusion circuit 750 may combine the information of separate sensors into a single field of view that combines separately detected objects while removing redundantly detected objects and surfaces.

The computing device 710 may further employ an algorithm circuit 760 that generates algorithm terms, such as relative shape stability (RSS) and subsequently executes the routines and processes shown in FIGS. 3-5. A classification circuit 770 may take sensor information along with other information, such as weather and site information, to classify one or more aspects of a detected object, such as state, movement direction, movement velocity, and object centroid location. The intelligent operation of the assorted circuits of the computing device 710 may generate a variety of information that may be utilized by an automation circuit 780 to proactively generate a taxiing strategy and react to changing taxiing conditions over time with automation instructions and/or automation tasks executed automatically or by manual aircraft operators.

While not required or limiting, a taxiing strategy may incorporate a variety of different policies, input data, and sensed information to prescribe one or more aircraft routes, speeds, and orientations that may be executed manually by human operators or automatically through the computer-directed execution of aircraft taxiing tasks. The proactive generation of a taxiing strategy that accounts for existing policies and site information may allow for efficient processing of sensor information and identification of situations where objects dictate changes in a prescribed aircraft taxiing route between a runway and a designated parking area.

Similarly efficient, the computing device 710 may proactively generate a classification strategy that prescribes sensing activity that provides efficient and accurate identification of an object's state (static/dynamic), orientation, movement direction, and movement velocity. Overall, the classification strategy may promote a reduction in detection errors, such as false positives and incorrect state characterizations. For example, the classification strategy may proactively assign sensing activity, such as resolution, frequency, centroid assignment, and sensor data fusion, that allows for efficient adaptation to encountered taxiing conditions, such as weather, air quality, and number of objects located on the periphery of the aircraft's field of view.

Through the utilization of the assorted aspects of the computing device 710, objects encountered by an aircraft may be accurately and efficiently detected and accurately classified, which enables safe and perceivably seamless automation of some, or all, of a taxiing operation for the aircraft that accommodate the assorted static surfaces and objects along with the dynamic objects.

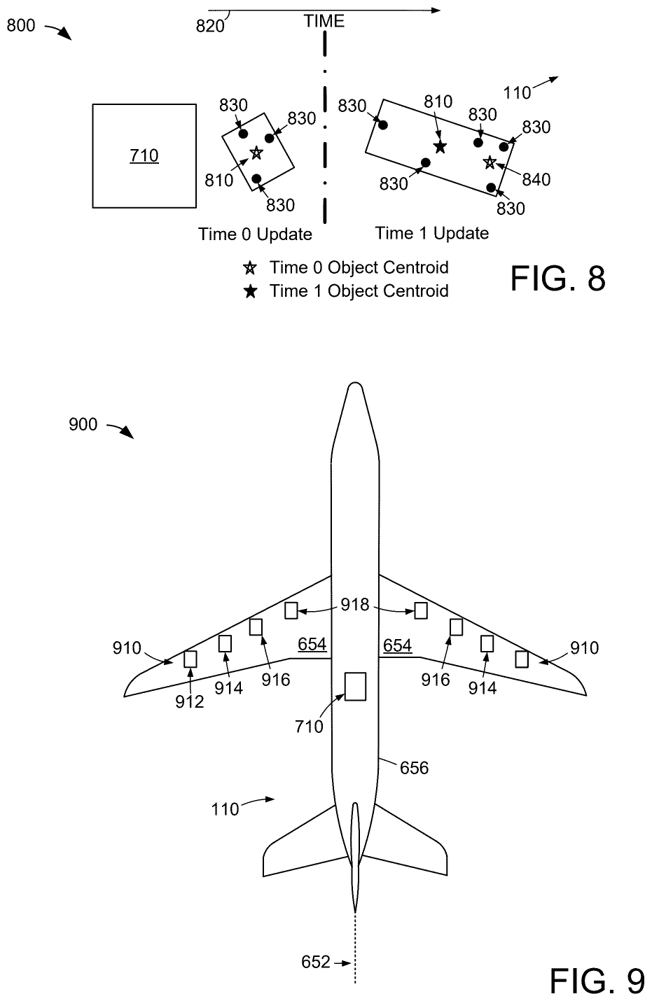

FIG. 8 conveys a block representation of portions of a taxiing environment 800 in which aspects of the object classification system 700 of FIG. 7 may be utilized to provide efficient and accurate characterization of one or more encountered objects. It is noted that aspects of the taxiing environment 800 shown in FIG. 8 may employ one or more of the algorithms, processes, and routines of FIGS. 3-6 to determine an object's centroid 810 and relative object stability over time.

The nature of widely spaced, inconsistent returns from static objects leads to the introduction of relatively large, simultaneous changes in the velocities of both object centroids and bounding box extents. However, objects which are truly in motion will exhibit relatively large velocity components, but stable shape characteristics with small extent velocities. Over time, as illustrated by solid arrow 820, an object classification system computing device 710 may assess a new location of an object centroid 840 compared to points 830 of an unstructured point cloud, which contributes to the accurate determination that an object is dynamic and the assessment of the dynamic object's movement direction and velocity.

FIG. 9 illustrates a top view line representation of portions of another taxiing environment 900 utilizing various aspects of an object classification system. The top view of the taxiing environment 900 conveys how a computing device 710 may be present within aircraft 110 and connected to an array 910 of sensors respectively positioned on separate positions along the wings of the aircraft 110. It is noted that the positions of the sensors is not limited and various sensors may be located in a single position on the fuselage or wings.

In accordance with various embodiments, the sensor array 910 utilizes different types of sensors, such as LiDAR sensors 912, optical sensors 914, acoustic sensors 916, and thermal sensors 918, positioned at strategic locations to collectively provide a field of view, as illustrated by segmented lines. It is noted that the assorted sensors of the array 910 may have individual fields of view that are fused by the computing device 710 into the collective field of view shown in FIG. 9.

Through the intelligent operation of the sensor array 910 and processing of the sensor information, the frequency of detection errors from an unstructured point cloud of the LiDAR sensors 912 may be reduced. The calculation and determination of a relative shape stability value for a detected object leverages the low error rate of the LIDAR sensors 912 to provide optimized object state classification between static and dynamic. Furthermore, the use of a relative shape stability value, and threshold, provides efficient and reliable object classification near the periphery of the field of view for the sensor array 910.

As a result of the improved efficiency and reliability of object classification as dynamic or static, the computing device 710 may provide more accurate evaluations and estimates of the orientation, movement direction, and movement velocity, which improves the automation of taxiing operations towards seamless adaptations to changes in a taxiing site. For instance, equipment, humans, or animals that present a safety hazard may be quickly assessed by the computing device 710 and translated into deviations from a predetermined taxiing route or speed. As another instance, accurate and efficient classification of an object by the computing device 710 may result in a determination that a minimal safety hazard exists and no deviation from a predetermined taxiing route or speed is necessary.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

1. An object classification system comprising:
a vehicle;
a computing device connected to a sensor mounted on the vehicle;
an object positioned in a field of view of the sensor;
wherein the sensor is configured to provide electronic sensor data representative of the object and the computing device determines a state of the object based on the electronic sensor data and in response to calculating a relative shape stability value for the object over time and a current track reliability of the object that is based on a number of missed detections and dynamic consistency that is based on both a dynamic counter and the current track reliability over a current evaluation time window; and
wherein the computing device deviates from a predetermined route for the vehicle in response to a classification of the object as a dynamic state and based on the current track reliability and the dynamic consistency that are determined.

2. The object classification system of claim 1, wherein the sensor is part of a sensor array.

3. The object classification system of claim 2, wherein the sensor array comprises a plurality of sensors each located on the vehicle.

4. The object classification system of claim 3, wherein the plurality of sensors comprises at least two different types of sensors.

5. The object classification system of claim 4, wherein a first type of sensor for the plurality of sensors is a LiDAR sensor.

6. The object classification system of claim 5, wherein a second type of sensor for the plurality of sensors is an optical sensor.

7. The object classification system of claim 1, wherein the computing device is positioned in the vehicle.

8. The object classification system of claim 1, wherein the predetermined route is between a runway and a gate.

9. The object classification system of claim 1, wherein the object is located proximal a periphery of the field of view of the sensor.

10. A method comprising:
detecting an object with a sensor, wherein the sensor is configured to provide electronic sensor data representative of the object;
calculating a relative shape stability value for the object over time by a computing device based on the electronic sensor data;
determining, by the computing device, a state of the object in response to the relative shape stability value;
determining, by the computing device, a current track reliability that is based on a number of missed detections and dynamic consistency that is based on both a dynamic counter and the current track reliability over a current evaluation time window; and
deviating from a predetermined route for a vehicle in response to a classification of the object as a dynamic state by the computing device.

11. The method of claim 10, wherein the relative shape stability value is calculated from a centroid velocity magnitude generated by the computing device.

12. The method of claim 10, wherein the relative shape stability value is calculated from a bounding box extent velocity magnitude computed by the computing device.

13. The method of claim 10, wherein the state is classified as dynamic after the computing device evaluates a threshold crossing window for the object.

14. The method of claim 10, wherein the computing device conducts at least one statistical test on velocity components of the object to classify the object as dynamic.

15. A method comprising:
detecting a first object and a second object with a sensor, wherein the sensor is configured to provide first electronic sensor data representative of the first object and second electronic sensor data representative of the second object;
calculating a relative shape stability value for each of the first object and second object over time with a computing device based on the first electronic sensor data and the second electronic sensor data, respectively;
determining, by the computing device, a first state of the first object in response to the relative shape stability value that is calculated based on the first electronic sensor data;
determining, by the computing device, a second state of the second object in response to the relative shape stability value that is calculated based on the second electronic sensor data;
determining, by the computing device, a current track reliability that is based on a number of missed detections and dynamic consistency that is based on both a dynamic counter and the current track reliability over a current evaluation time window;
classifying, by the computing device, each of the first object and second object as a dynamic state with the computing device based on the current track reliability and the dynamic consistency that are determined; and
deviating from a predetermined route for a vehicle in response to a tracked dynamic state of first object by the computing device.

16. The method of claim 15, wherein the first object has a tracked dynamic state that differs from a tracked dynamic state of the second object.

17. The method of claim 15, wherein the tracked dynamic state of the first object is determined by the computing device to pose a safety risk to the vehicle.

18. The method of claim 17, wherein the tracked dynamic state of the second object is determined by the computing device to pose no safety risk to the vehicle.

19. The method of claim 15, wherein the computing device deviates a speed of the vehicle in response to the tracked dynamic state of the first object.

20. The method of claim 15, wherein the computing device determines an orientation for the first object in conjunction with the tracked dynamic state.
